(19) United States
(12) Patent Application Publication
(10) Pub. No.: US 2024/0350908 A1
(43) Pub. Date: Oct. 24, 2024

(54) SYSTEMS AND METHODS FOR SYNCHRONIZED HIGH-SPEED SEQUENCING AND LOADING OF ASYNCHRONOUS MULTI-PLATFORM DATA

(71) Applicant: TLM Partners, Inc., Villa Park, CA (US)

(72) Inventors: Jacob HAWLEY, Villa Park, CA (US); Mark HU, Seattle, WA (US); Murray VINCE, Woodinville, WA (US); Jeremy PAVIER, Suffolk (GB); Christopher BURNS, Salt Lake City, UT (US); Hrafnkell Freyr HLOEDVERSSON, Copenhagen K (DK); Andrew MEDVEDEV, Minsk (BY)

(73) Assignee: TLM Partners, Inc., Villa Park, CA (US)

(21) Appl. No.: 18/688,133

(22) PCT Filed: Aug. 30, 2022
(86) PCT No.: PCT/US2022/042055

§ 371 Date: Feb. 29, 2024

Related U.S. Application Data
(60) Provisional application No. 63/238,318, filed on Aug. 30, 2021.

(51) Int. Cl. A63F 13/355; A63F 13/358; A63F 13/77; A63F 13/795

(52) U.S. Cl. CPC A63F 13/355; A63F 13/77; A63F 13/795; A63F 13/358

(57) ABSTRACT

Embodiments of the present disclosure may include a method for providing cross-platform multi-user compatibility in a cross-play cloud computing environment, the method including simulating at least one instance of an entertainment program. Embodiments may also include providing access to the at least one instance of the entertainment program asynchronously from two or more client devices via one of a plurality of independent entertainment platforms. In some embodiments, the two or more client devices may be able to engage in multi-user functionality within the at least one instance of the entertainment program via the one of a plurality of independent entertainment platforms. Embodiments may also include synchronizing the multi-user functionality within the at least one instance of the entertainment program.

### TECHNICAL FIELD

This description relates to data capture and data handling techniques.

### BRIEF SUMMARY

Embodiments of the present disclosure include methods and systems for providing cross-platform multi-user compatibility in a cross-play cloud or client computing environment, the methods and systems including simulating at least one instance of an entertainment program. Embodiments may also include providing access to the at least one instance of the entertainment program asynchronously from two or more client devices via one of a plurality of independent entertainment platforms. In some embodiments, client devices may be game controllers such as gamepads, yokes, steering wheels and pedals, and gun replicas. The client devices may be connected to other client devices. The client devices may be connected to one or more cloud computing services that may be connected to one or more entertainment platforms. In some embodiments, the two or more client devices can engage in multi-user functionality within the at least one instance of the entertainment program via the one of a plurality of independent entertainment platforms. Embodiments may also include synchronizing the multi-user functionality within the at least one instance of the entertainment program.

### BACKGROUND

Entertainment systems, including multiplayer gaming systems, have traditionally been comprised of closed ecosystems including licensed game franchises and, in some cases, proprietary hardware and software for playing games. Once a customer chooses a platform on which to play, they generally play within that platform's ecosystem and are unable to play with others on other platforms. For example, this has been how video game console makers have competed for customers over the last several decades.

An example of a game platform is a system made up of a CPU, Memory, OS, and Graphics Processor. Each game platform often has its own discrete hardware architecture and software ecosystem designed to specifically wall users off and keep them ‘captured.’ This has been the state of the art since the beginning of gaming consoles (e.g., Sega, Nintendo 64, Commodore 64, etc.).

There are a few types of gaming platforms, non-limiting examples of which include:

PC Platforms include closed or open-source software operating systems running on PC hardware. These vary primarily by operating system (OS), such as Windows, MacOS, and Linux. Examples of companies hosting this type of gaming platform are Valve's Steam (Steam) or Epic's Epic Game Store (EGS). There are others, including Good Old Games (GOG) and the Microsoft Windows Store; many of the larger video game publishers run their own systems domestically and internationally (e.g., TenCent runs a system similar to Steam in China called TenCent Cloud, and EA runs its own system called EA Origin).

Gaming consoles include proprietary, self-contained hardware systems. Examples of these include Microsoft Xbox, Sony PlayStation, and Nintendo Switch.

Mobile systems include Apple's iOS and Samsung's Android OS.

Game Engines: There are many game engines, however only a few have risen to prominence. A game engine often includes a collection of libraries, software development kits (SDK's), and sample source code for programming video games.

The Unreal Engine (UE) is based on C++ and is currently developed and shipped by Epic Games. Epic in recent years has developed and begun to ship its own gaming platform to compete with the Consoles and the largest PC platform, Valve's Steam. UE is most popular for PC and Console development.

Unity is the leading competitor to the Unreal Engine. Its appeal to the market is that it is based on C# and has a convenient ‘programmer's workbench’ feel that makes it easier to learn. Unity is popular for mobile game development.

Node JS is the leading web-based game engine and is based on Java Script. The appeal of NodeJS is that, because it is Java-based, it is very easy for any web-savvy HTML5 developer to use it to produce a game. NodeJS is most popular for web-based games.

Ecosystems: each entertainment platform has its own ecosystem designed to keep the audience ‘captured’ to maximize time spent on the platform and revenues from users.

For decades, the various platforms have each developed their own ecosystems, different CPU/GPU architectures, SDK's, tools, API's, and interfaces. The state of the art has been for game developers to create a unique and discrete version of the games they are developing that is specific to each of the major gaming platforms.

For example, and as a hypothetical, a game developer may make a game, for example a fun new multiplayer game called TLM_Game. In this hypothetical example, TLM_Game is the base game, lead SKU, or the first implementation of the multiplayer game. The “fun” or key sales component of the multiplayer game is playing with other players.

To support multiple platforms, a game developer would have to create a game version for Xbox One, call it TLM_Game_Xbox-One, which utilizes the specific microprocessor architecture, operating system, graphics processor, memory architecture, and various other Xbox One specific interfaces and limitations. If a game developer wanted the TLM_Game to work on another platform, the developer or publisher would then need to “port” (e.g., rewrite, recompile, and in some cases create completely new game logic, source-code, and other necessary changes to make it ‘compatible’ with the target platform). The TLM_Game_Xbox-One version is wholly different from TLM_Game_PS4, the PlayStation 4 version of the game. Similarly, this is true of all of the PC OS's and console vendors TLM_Game_Xbox-X, TLM_Game_PS4, TLM_Game_PS5, TLM_Game_Nintendo_Switch.

Additionally, for web-based or other closed operating systems, a version will need to be completely rewritten to target NodeJS or Cocos or HTML5. For simplicity and for purposes of the following description, all of these will be described together into TLM_Game_Web-Based.

Because of this complexity, in general, most game development is done on PC and targets Steam or the Epic Game Store (EGS) as the platform for the primary first SKU. This allows developers to focus on getting the first projects completed and fully functional before starting the arduous task of ‘porting’ to all of the other various platforms. In our example, we would create TLM_Game_PC_Steam or TLM_Game_PC_EGS.

As mentioned above, each of these systems is technically very different and there has been little to no effort to make them compatible with one another for game developers and users. In fact, by design, Sony and Microsoft have added technical hurdles, security, and obfuscation to keep their customers captive to each respective proprietary console.

In practice this has resulted in a segmentation in the market for video game players. Not surprisingly, once you become an “Xbox” gamer, or “PlayStation” gamer, there is a natural tendency for gamers to become ‘zealots’ if for no other reason than their own investment in games, brand loyalty, and of course it is really expensive to have multiple gaming consoles, expensive libraries of games, and very costly PC's.

Naturally, as each successive generation of gaming platforms is improved, compatibility issues arise for previous generations of the platform. It is not uncommon for incompatibilities to be related to differentiating features and functionality that further lock users/games/players into the “next generation” of a particular platform. Unfortunately for the games/users/players of each of their platforms, there are many times when, even on their own platform, incompatibilities make it impossible for them to play together.

So in our hypothetical, the users/gamers/players of the TLM_Game are limited to playing with other users of their own platform (or even worse, a specific generation of their platform).

As such, the state of the art has been TLM_Game_PC_Steam users play with PC_Steam users; TLM_Game_PC_EGS users play with PC_EGS users; TLM_Game_Xbox-X users play with others on Xbox-X; TLM_Game_Xbox-S users play with others on Xbox-S; TLM_Game_PlayStation4 users play with others on PlayStation4; TLM_Game_PlayStation5 users play with others on PlayStation5, and so on.

### BRIEF DESCRIPTION OF THE FIGURES

FIG. 1 depicts a high-level logic flow of an operational process for providing cross-platform multi-user compatibility in a cross-play cloud computing environment.

FIG. 2 depicts additional exemplary operations in a high-level logic flow of an operational process for providing cross-platform multi-user compatibility in a cross-play cloud computing environment.

FIG. 3 depicts an example architectural overview of a cross-play system designed to enable cross-platform multi-user compatibility with existing third-party services in a cross-play cloud computing environment.

FIG. 3A depicts system features without the instant cross-play technology.

FIG. 3B depicts system features with the instant cross-play technology.

FIG. 4 depicts an example system architecture for the instant cross-play systems and methods.

FIG. 5 depicts an example system architecture for the instant cross-play systems and methods.

FIG. 6 depicts an overview and features of extract, load, and transform methodologies.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

According to various embodiments of the present disclosure, asynchronous data may be collected from multiple devices that can include the input from a gamepad, video input, audio input, and/or other unstructured or structured data. The data may be extracted from the memory of the device from which it came, whether that is from the solid state drive (SSD) of a gaming console or the RAM of a gamepad. All of the data from all of the devices within the specified system may be placed into a single, cloud-based data lake. In some embodiments, this data lake could be housed within the confines of a public cloud provider such as Microsoft or Amazon, a private cloud environment, or a hybrid environment using some aspects of both a public and private cloud network.

In various embodiments, the asynchronous data collected from multiple devices may be processed on a client device or other edge processing environment.

For these embodiments, employed within the cloud infrastructure or edge processing environment are multiple algorithms, including one that can timestamp relevant data items as appropriate for later usage in a synchronized environment such as a real-time multi-player cloud-based game. In addition, both simple and rich data transformations are possible. For example, a single or a series of button presses on a gamepad controller can be transformed into specific actions or movements of a character or object within a virtual environment. At a high level, the process may be performed using an Extract Transform Load (ETL) process or an Extract Load Transform (ELT) process in conjunction with a data lake.

An ETL process may include three processes, an asynchronous extract process, an asynchronous transform process, and a synchronous load process:
Extract—Asynchronous

Data is extracted that can be controller input, player position, haptic data, sounds data, or any other data received by the computing environment. Data may be extracted from memory of the device the user is gaming on. In terms of process, data can be written into a database. Data can be stored incrementally and/or temporarily once extracted. In the gaming context, these processes must be sequenced accurately and performed quickly to allow for rapid loading and a seamless, low-latency user experience.
Transform—Asynchronous

Data is transformed, sent, and at least temporarily stored in the cloud. Once stored, a transform operation may be performed, such as transforming controller input into raster output (e.g., from button press to what a user sees on a screen). As with extraction of data, in the gaming context, these processes in various embodiments must be performed quickly to allow for rapid loading and a seamless, low-latency user experience.
Load—Synchronous

Loading refers to moving data that has at least been temporarily stored in the cloud onto another device to be rendered or displayed. In various embodiments, data taken from the cloud is extracted, preferably in a defined sequence. For these embodiments, this step may be done quickly; algorithms may be used to make it appear that actions are taken in real-time on multiple devices simultaneously. Systems may be employed that use a timestamp/master clock to synchronize loading of data on multiple devices.

Available ETL tools that may be employed include, for example, Xplenty, Talend, Stitch, Informatica Power Center, Oracle Data Integrator, Skyvia, Fivetran, and so forth. Several of these also accommodate aspects of ELT architectures.

The Extract Load Transform (ELT) process is similar to, but distinct from, the Extract Transform Load (ETL) process described above. It is a data transformation process that allows for raw data to be transformed directly in a data warehouse or data lake, versus in ETL where the transformation typically occurs on a staging server. In ELT, the “staging” area where the transformation occurs is actually a database such as Hadoop that is already part of the data warehouse. This newer ELT approach is useful when the data is unstructured or nonrelational, such as audio or video. This is particularly true in gaming environments, where advances in game design are creating the need for a large variety of extracted data types. ELT data load times into a data warehouse or data lake are typically faster than ETL load times, and given that the entire raw data is loaded into a data warehouse, it can facilitate more flexibility with data analytics than with ETL, something that is increasingly common when evaluating user data and gameplay data with online games.

Available ELT tools that may be employed include, for example, Kafka, Talend, StreamSets, Airflow, Blendo, Hevo Data, Matillion, Etleap, Luigi, and so forth. Several of these tools also accommodate aspects of ETL architectures.

In some embodiments, schemas may be employed that are designed to model the data inflows from each platform and to determine the necessary transformations. ETL/ELT software is then written, specifying the details of application program interface (API) endpoints to call, how to normalize the data, and how to load it into the destination clients. Embodiments of the present disclosure may take advantage of API's and ETL/ELT tools to sequence data transformation and loading such that large quantities of cross-platform data can be processed with very low latency and low error rates.

To summarize, the embodiments describe herein may employ a series of cross-play technologies that allow users/gamers/players to play from their platform of choice with other users/gamers/players using other platforms while maintaining a high quality of gameplay in terms of frame rate, resolution, and latency.

The instant cross-play technology may have broad implications in many areas, including but not limited to, client implementations of each of the platforms within the ecosystems, and in providing consistent and ‘as expected’ behaviors on each of the platforms.

In one example of the instant cross-play technology, the methods and systems may resolve the compute discrepancies between, for example, a user on a PS5 and a Nintendo Switch. This includes:

Providing a multiplayer system to synchronize and run independent simulation entertainment software running asynchronously on disparate microprocessors, and/or operating systems, and/or consoles, and/or platforms, and/or networks.

Providing a multiplayer system to synchronize and run independent simulation entertainment software running asynchronously on PlayStation 4 for two or more players to play with other user/gamer/players each running their own version of the base game on their own system (e.g., PS4, PS5, Xbox One, Xbox S, Xbox X, Nintendo Switch, PC-Steam, PC-EGS, or PC-Windows) to play with another user/gamer/players each on disparate microprocessors, and/or operating systems, and/or consoles, and/or platforms, and/or networks.

TLM_Game=independent simulation entertainment software

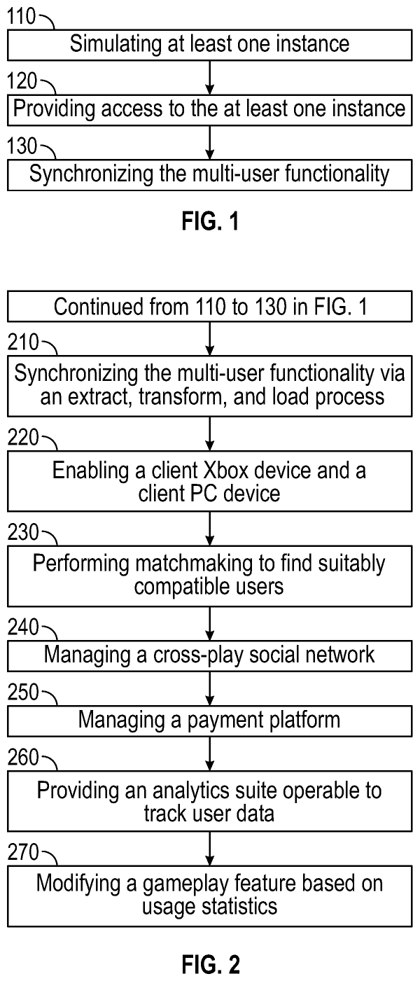

FIG. 1 shows an example method according to some embodiments of the present disclosure. In particular, FIG. 1 illustrates a method for providing cross-platform multi-user compatibility in a cross-play cloud computing environment, the method including 110 to 130. At 110, the method may include simulating at least one instance of an entertainment program. At 120, the method may include providing access to the at least one instance of the entertainment program asynchronously from two or more client devices via one of a plurality of independent entertainment platforms. At 130, the method may include synchronizing the multi-user functionality within the at least one instance of the entertainment program.

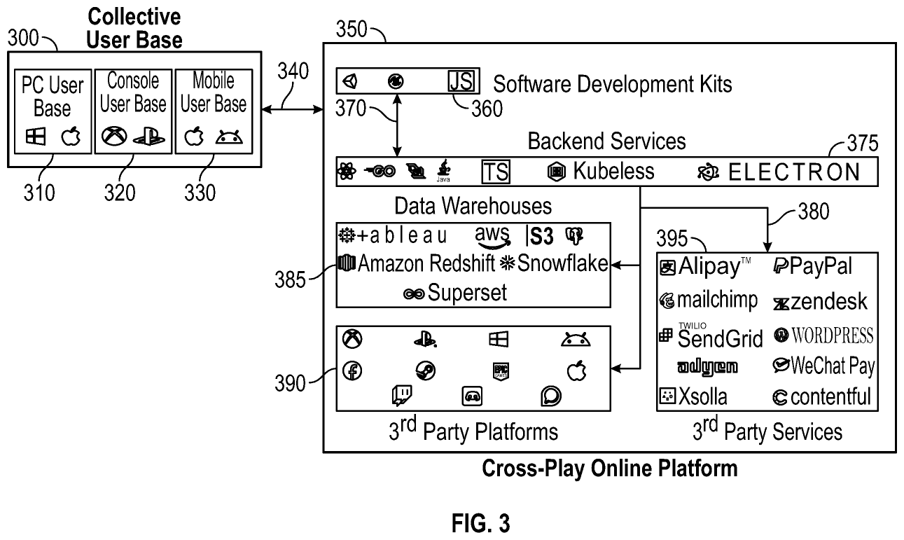

FIG. 2 shows another example method according to some embodiments of the present disclosure. In some embodiments, the method includes one or more operations that may supplement operations 110 to 130 illustrated in FIG. 1. At 210, the method may include synchronizing the multi-user functionality via an extract, transform, and load (ETL) process, such as described above. At 220, the method may include enabling a client Xbox device and a client PC device to engage in a synchronized multiplayer session of a massive multi-player online role-playing game. At 230, the method may include performing matchmaking to find suitably compatible users.

At 240, the method may include managing a cross-play social network, optionally including compiling a friends list. At 250, the method may include managing a payment platform. At 260, the method may include providing an analytics suite operable to track user data including at least one of usage statistics, time-in-game statistics, user activity statistics, multiplayer statistics, or user progress statistics. At 270, the method may include modifying a gameplay feature based on usage statistics of the feature.

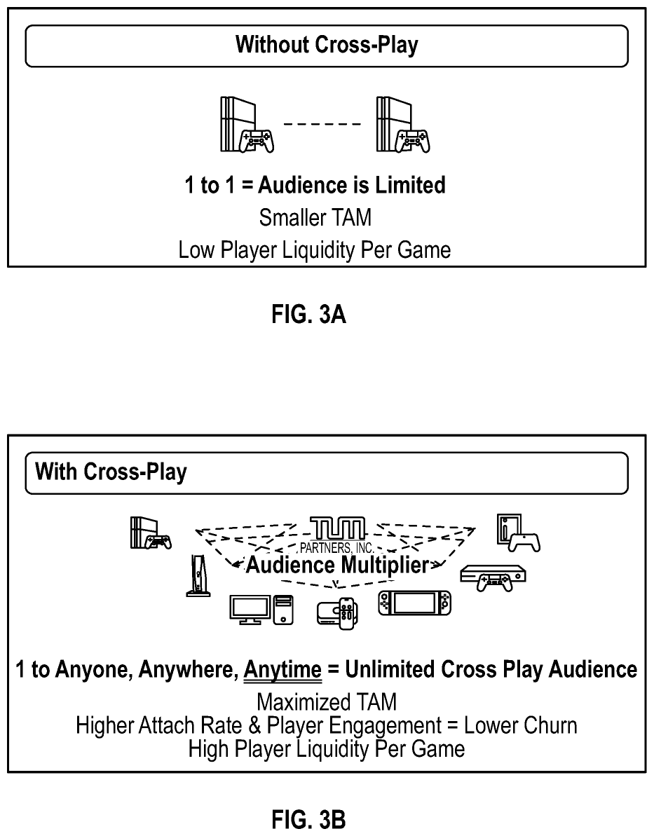

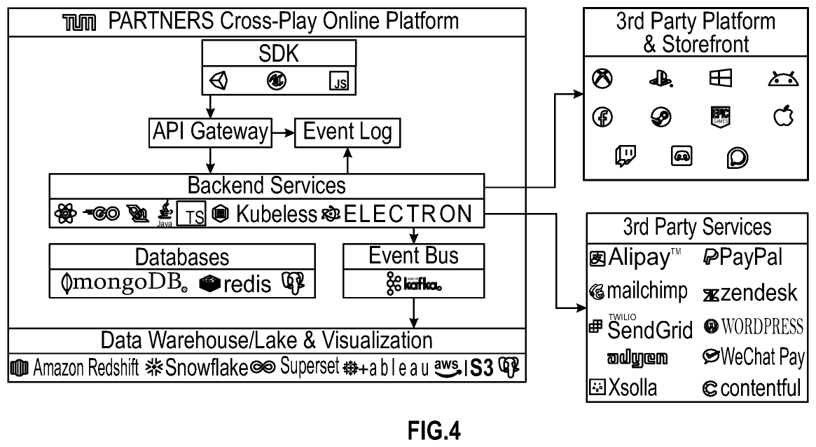

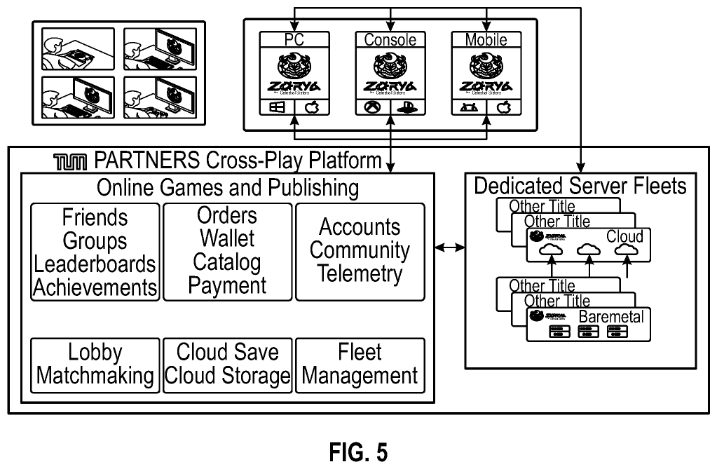

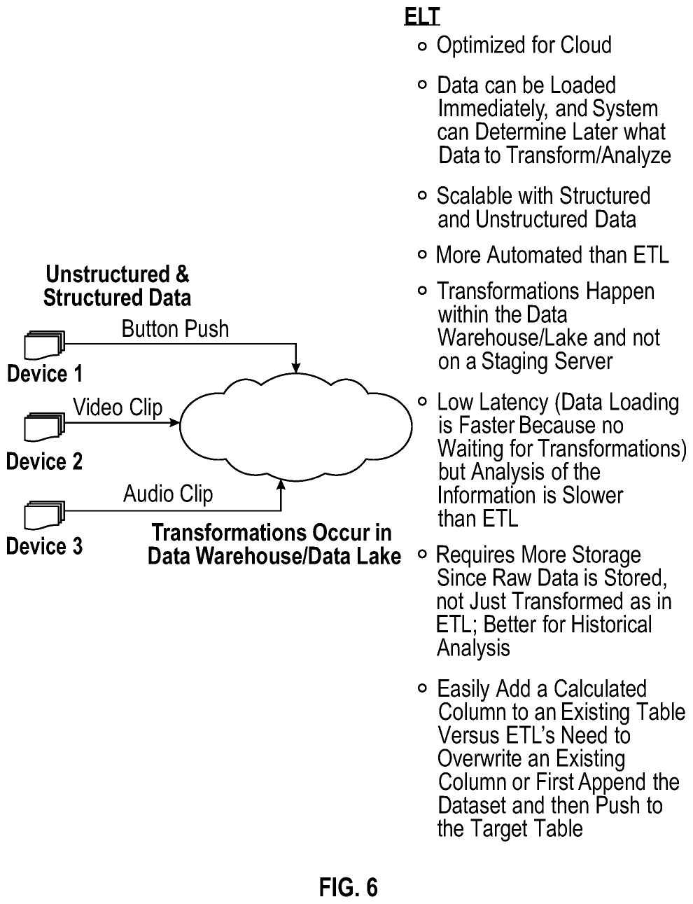

FIG. 3 shows an example system according to some embodiments of the present disclosure. An example multi-platform user base is shown in 300 containing collective user bases, each of a different platform in 310, 320, and 330 (illustrated as PC User Base 310, Console User Base 320, and Mobile User Base 330).

In various embodiments, PC User Base 310 represents the collective PC user base typically represented by the Windows and macOS operating systems, although additional operating systems such as Linux are possible. Windows here is defined generically as representing all of Microsoft's active Windows operating systems used for gaming, such as Windows 7, Windows 8, Windows 10, and so forth. Similarly, macOS collectively represents all active versions of the macOS used for gaming such as Monterey, Big Sur, Catalina, Mojave, etc. Finally, Linux also represents all current flavors of Linux used for gaming which can include both different versions of a particular flavor (e.g., Ubuntu 14.04 and Ubuntu 18.04) as well as different flavors such as Debian, Red Hat Enterprise Linux, and Fedora). Like mobile operating systems, PC operating systems may be run on a large variety of hardware configurations provided by vendors as diverse as HP, Dell, Intel, Nvidia, and Razer.

In various embodiments, Console User Base 320 represents the collective console gaming system user base, now typically represented by Xbox and PlayStation users. Again, both the Xbox and PlayStation user bases may refer to all active users using any version of Xbox or PlayStation to game. For example, an Xbox user could be using an original Xbox first launched in 2001, an Xbox One launched in 2013, or the most current Xbox Series X launched in 2020. Similarly, a PlayStation user that is part of its collective user base could be using a PlayStation first launched in 1994, a PlayStation 2 6launched in 2000, a PlayStation 5 launched in 2020, or any other version of the console.

In various embodiments, Mobile User Base 330 represents the collective mobile gaming system user base, most commonly associated with the iOS and Android operating systems. The user bases can be using any active version of the operating systems for gaming, such as iOS 10, iOS 15, or its variant iPadOS 15. Similarly, a mobile user could be using any one of Android Version 5.0 Lollipop, Version 10, Version 12, and so forth. Of note is that like PC operating systems, mobile operating systems may be used on a wide variety of mobile hardware devices provided by companies such as Apple (e.g., iPhones), Samsung (e.g., Galaxy phones), Xiaomi, Huawei, Oppo, Motorola, and so forth.

Arrows 340, 370, and 380 represent communications between different elements of the system. These communications can be via wired (e.g., Ethernet) or wireless (e.g., cellular or Wi-Fi) means, and can be synchronous or asynchronous. These communications may be recorded or logged, and may be queued via a bus. Arrow 340 represents the communication between the collective user bases 310, 320, and 330 and the exemplary Cross-play Online Platform 350. Arrow 370 represents the communication between Software Development Kits 360 and Backend Services 375. Arrow 380 represents communications between Backend Services 375 and Data Warehouses 385, 3^{rd} Party Platforms 390, and 3^{rd} Party Services 395.

Software Development Kits 360 are sets of software tools and programs that enable developers to connect their games and services to the Cross-play Online Platform 350. Commonly known as “SDK's”, these kits are typically focused on enabling existing groups of game developers using specific platforms to quickly, easily, and with low cost add functionality to their gaming titles. SDK's are commonly written for the Unreal and Unity gaming platforms since many developers use these platforms to design their games. JavaScript is another gaming platform upon which games are developed, particularly mobile games.

In order for the Collective User Base 300 to properly connect to the Cross-play Online Platform 350, SDKs 360 must enable access to Backend Services 375. Backend Services 375 include those services which enable the Cross-play Online Platform 350 to deploy server and serverless code such as Kafka messaging system triggers, runtimes using Python, Node.js, Ruby, PHP, Golang, and .NET, and a variety of monitoring and reporting systems. In addition, Backend Services 375 enables the Cross-play Online Platform 350 to access system, gaming environment, and user data stored in Data Warehouses 385, along with 3^{rd} Party Platforms 390 and 3^{rd} Party Services 395. The overall purpose of the Backend Services 375 is to enable Cross-play Online Platform 350 the flexibility to engage with any platform or service a user may desire regardless of its underlying infrastructure. For example, if an individual that was part of the collective Mobile User 320 user base was using iOS 14 on an Apple device and wanted to play an Xbox Live game with an individual part of the Console User Base 320 and pay for it via Paypay, Backend Services 375 would seamlessly facilitate that transaction and gameplay environment, and assist in recording and auditing it as directed.

Data Warehouses 385 represents the data warehouses and data lakes into which user, gaming, and system data is placed. Data Warehouses 385 can include a variety of different database structures and services, and can include both structured and unstructured data. Data Warehouses 385 can include transformed and untransformed data. Representative examples of database structures include Amazon's Web Services (AWS), snowflake, and Superset.

3^{rd} Party Platforms 390 includes those platforms that Cross-play Online Platform 350 makes available to its connected user base. These platforms are often associated directly with console providers, game developers, and streaming game providers. These platforms often provide digital media delivery and enable users to directly purchase game content. For example, one platform is Xbox network, formerly known as Xbox Live. This platform is the account for the Xbox console system, and enables users to purchase games for the Xbox console. However, it also allows users to purchase gaming content that can be played on a PC platform using the Microsoft Windows operating system. In addition, games playable on the iOS and Android mobile operating systems are also accessible via the Xbox network. Similarly, Discord is an instant messaging, VoIP, and digital distribution platform with over 250 million active users as of the end of 2020. It is compatible with Windows, macOS, Android, IOS, iPadOS, and Linux.

3^{rd} Party Services 395 includes those services that Cross-play Online Platform 350 makes available to its connected user base. These services can be payment services such as PayPal and Alipay, communication services such as Mailchimp, and content management services such as WordPress and Contentful.

Embodiments of the present disclosure include a system for providing cross-platform multi-user compatibility in a cross-play cloud computing environment, wherein the system may execute at least one instance of an entertainment program. The system may include at least two network-connected gaming systems that are in communication via at least one cross-play hosting system. In some embodiments, client devices, for example, gaming systems, may be replaced with a multimedia system. For example, a media watching platform where two or more system subscribers watch a media title together. The cross-play hosting system may be provided within a network-attached gaming system, an on-premise server, or remote server/cloud-based service. In some embodiments, a first client device may send data to a cross-platform hosting service provided on a server. The cross-platform hosting service itself may be in communication with, e.g., sending and receiving data, a second gaming console. Embodiments may also include providing simultaneous access to at least one instance of an entertainment program asynchronously from two or more client devices via one of a plurality of independent entertainment platforms. In some embodiments, the two or more client devices can engage in multi-user functionality within the at least one instance of the entertainment program via the one of a plurality of independent entertainment platforms. Embodiments may also include synchronizing the multi-user functionality within the at least one instance of the entertainment program.

In some embodiments, the synchronizing of the multi-user functionality within the at least one instance of the entertainment program includes synchronizing the multi-user functionality via an extract, transform, and load (ETL) process. In some embodiments, the ETL process may be performed such that at least some of the unstructured data associated with the multi-user functionality is extracted to a data warehouse. In some embodiments, the ETL process may be done such that at least some of the unstructured data associated with the multi-user functionality is extracted to a data lake. In various embodiments, the ETL process may include extraction from databases such as RDBMS, NoSQL, and OLTP. In some embodiments, the ETL process may also incorporate extraction from XML, JSON, CSV, XLS and other file types associated with the multi-user functionality. In some embodiments, the ETL process may incorporate extraction from web applications and associated APIs and webhooks that release application data and are related to the multi-user functionality.

In various embodiments, the ETL process may be asynchronous, so there may be a staging area for the extracted data before the transformation stage. In some embodiments, the staging area is a server. In some embodiments, the staging area includes a public cloud, private cloud, or hybrid cloud incorporating public and private cloud characteristics. In some embodiments, unstructured data related to multi-user functionality may be stored, at least temporarily, in a data warehouse or a data lake before it is transformed. In such an instance, the ETL process may be modified to allow the transfer and storage of this unstructured data in the data warehouse or data lake.

In some embodiments within the ETL process, the transformed data is analyzed within a data warehouse. In some embodiments, the transformed data is analyzed within a data lake. The data analysis stage of the ETL process may include business analytics tools that help enable the multi-user functionality of the at least one entertainment program. In some embodiments, the entertainment program includes at least one of a role-playing game, a first-person shooter, a battle royale game, an adventure game, a driving game, a side scroller, a puzzle game, a flight simulator, a rogue-like game, a sports game, or an educational game.

In some embodiments, the multi-user functionality includes at least one of multiplayer gaming, multi-user virtual experience, multi-user remote viewing, or multi-user account management. In some embodiments, the synchronizing the multi-user functionality within the at least one instance of the entertainment program is performed by a cross-play cloud computing environment. In some embodiments, the cross-play cloud computing environment includes at least one of a datacenter, a virtual private network, a public cloud, a private cloud, a virtual private cloud, a hybrid cloud, or a multi-cloud environment.

In some embodiments, the cross-play cloud computing environment includes at least one of a user account database, a user authentication requirement, a user verification requirement, secure sign-in capability, a database of user activity history, or a vault containing user-owned assets. In some embodiments, the cross-play cloud computing environment includes dedicated server fleets. In some embodiments, the cross-play cloud computing environment is operable to resolve any compute discrepancies between the plurality of independent entertainment platforms. In some embodiments, the cross-play cloud computing environment is operable to resolve any perceived user experience discrepancies among users operating across the plurality of independent entertainment platforms.

In some embodiments, the plurality of independent entertainment platforms includes disparate asynchronous client systems. In some embodiments, the at least one instance of an entertainment program includes at least one of a multi-player video game, a single-player virtual reality game, a multi-player virtual reality game, a flight simulation game, a racing simulation game, an online video game, or a mobile video game. In some embodiments, the two or more client devices include at least one of a desktop computer, a laptop computer, a mobile phone, a gaming console, a mobile gaming console, or a virtual reality device.

In some embodiments, the gaming console includes at least one of an Xbox or a PlayStation console. In some embodiments, the synchronizing the multi-user functionality within the at least one instance of the entertainment program includes a) receiving input from disparate asynchronous client systems running independent instances of the entertainment program. Embodiments may also include b) simulating multiplayer gameplay for the at least one instance of an entertainment program based on the input from the disparate asynchronous client systems.

In some embodiments, the synchronizing the multi-user functionality within the at least one instance of the entertainment program includes synchronizing the multi-user functionality via an extract, transform, and load process. In some embodiments, the entertainment program includes at least one of a role-playing game, a first-person shooter, a battle royale game, an adventure game, a driving game, a side scroller, a puzzle game, a flight simulator, a rogue-like game, a sports game, or an educational game.

In some embodiments, the synchronizing the multi-user functionality within the at least one instance of the entertainment program includes enabling a client Xbox device and a client PC device to engage in a synchronized multiplayer session of a massive multi-player online role-playing game. In some embodiments, the disparate asynchronous client systems include software running asynchronously on at least one of disparate microprocessors, disparate operating systems, or disparate networks.

In some embodiments, none of the independent instances of the entertainment program are from the same independent entertainment platform. In some embodiments, the plurality of independent entertainment platforms includes, at least one of an operating system, a game console, an online gaming platform, or a mobile gaming platform. In some embodiments, the two or more client devices are able to engage in synchronized multiplayer gameplay via disparate input modes.

In some embodiments, the disparate input modes include at least one of keyboard, mouse, keyboard and mouse, virtual reality controller, trackpad, trackball, video game controller, video game remote control, gesture control, voice control, head tracking, body tracking, brain signal control, or eye movement control. In some embodiments, the cross-play cloud computing environment is configured to send a haptic signal of events to the two or more client devices to effectuate a distributed and coordinated haptic multi-user experience.

Embodiments of the disclosed methods may also include at least one of, a) recording the multiplayer gameplay within the at least one instance of the entertainment program. Embodiments may also include b) saving a recording of the multiplayer gameplay within the at least one instance of the entertainment program. Embodiments may also include c) playing back a recording of the multiplayer gameplay within the at least one instance of the entertainment program. Embodiments may also include d) editing a recording of the multiplayer gameplay within the at least one instance of the entertainment program. Embodiments may also include c) publishing a recording of the multiplayer gameplay within the at least one instance of the entertainment program. Embodiments may also include f) sharing a recording of the multiplayer gameplay within the at least one instance of the entertainment program.

Embodiments of the disclosed methods may also include performing matchmaking to find suitably compatible users. Embodiments may also include managing a cross-play social network including one or more of a) compiling a friends list. Embodiments may also include b) compiling a group membership list. Embodiments may also include c) tracking online status. Embodiments may also include d) compiling a leaderboard. Embodiments may also include c) compiling an achievement list. Embodiments may also include or f) establishing a moderator role.

Embodiments of the disclosed methods may also include managing a payment platform including one or more of, a) providing a game or other media catalog. Embodiments may also include b) providing an online ordering platform. Embodiments may also include c) providing for secure user wallet accounts. Embodiments may also include or d) providing a secure payment platform. Embodiments may also include providing an analytics suite operable to track user data including at least one of usage statistics, time-in-game statistics, user activity statistics, multiplayer statistics, or user progress statistics. Embodiments may also include modifying a gameplay feature based on usage statistics of the feature. In some embodiments, the gameplay feature includes at least one of a level of difficulty, a reward frequency, a powerup frequency, or a points award.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having ordinary skill in the art will recognize that the state of the art has progressed to the point where there is little distinction left between hardware, software, and/or firmware implementations of aspects of systems; the use of hardware, software, and/or firmware is generally a design choice representing cost vs. efficiency tradeoffs (but not always, in that in certain contexts the choice between hardware and software can become significant). Those having ordinary skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

In some implementations described herein, logic and similar implementations may include software or other control structures suitable to operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise controlling special-purpose components. Specifications or other implementations may be transmitted by one or more instances of tangible or transitory transmission media as described herein, optionally by packet transmission or otherwise by passing through distributed media at various times.

Alternatively or additionally, implementations may include executing a special-purpose instruction sequence or otherwise operating circuitry for enabling, triggering, coordinating, requesting, or otherwise causing one or more occurrences of any functional operations described above. In some variants, operational or other logical descriptions herein may be expressed directly as source code and compiled or otherwise expressed as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar modes of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those having ordinary skill in the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a USB drive, a solid state memory device, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read-only, etc.)), and/or electrical circuitry forming a communications device (e.g., a modem, communications switch, optical-electrical equipment, etc.). Those having ordinary skill in the art will recognize that the subject matter described herein may be implemented in an analog or digital fashion or some combination thereof.

Those skilled in the art will recognize that at least a portion of the devices and/or processes described herein can be integrated into a data processing system. Those having ordinary skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

In certain cases, use of a system or method as disclosed and claimed herein may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory.

Further, implementation of at least part of a system for performing a method in one territory does not preclude use of the system in another territory.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., operations), devices, objects, and the discussion accompanying them are used as examples for the sake of conceptual clarity and that various configuration modifications are contemplated. Consequently, as used herein, the specific examples set forth and the accompanying discussion are intended to be representative of their more general classes. In general, use of any specific example is intended to be representative of its class, and the non-inclusion of specific components (e.g., operations), devices, and objects should not be taken to be limiting.

With respect to the use of substantially any plural and/or singular terms herein, those having ordinary skill in the art can translate from the plural to the singular or from the singular to the plural as is appropriate to the context or application. The various singular/plural permutations are not expressly set forth herein for sake of clarity.

The herein described subject matter sometimes illustrates different components contained within, or connected with, different other components. It is to be understood that such depicted architectures are presented merely as examples, and that in fact many other architectures may be implemented which achieve the same functionality. In a conceptual sense, any arrangement of components to achieve the same functionality is effectively “associated” such that the desired functionality is achieved. Therefore, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of “operably couplable” include but are not limited to physically mateable or physically interacting components, wirelessly interactable components, wirelessly interacting components, logically interacting components, or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such a recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having ordinary skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having ordinary skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented as sequences of operations, it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method for providing cross-platform multi-user compatibility in a cross-play cloud computing environment, the method comprising:
simulating at least one instance of an entertainment program;
providing access to the at least one instance of the entertainment program asynchronously from two or more client devices via one of a plurality of independent entertainment platforms;
wherein the two or more client devices are able to engage in multi-user functionality within the at least one instance of the entertainment program via the one of a plurality of independent entertainment platforms; and
synchronizing the multi-user functionality within the at least one instance of the entertainment program.

2. The method of claim 1, wherein the multi-user functionality comprises:
at least one of multiplayer gaming, multi-user virtual experience, multi-user remote viewing, or multi-user account management.

3. The method of claim 1, wherein the synchronizing the multi-user functionality within the at least one instance of the entertainment program is performed by a cross-play cloud computing environment.

4. The method of claim 3, wherein the cross-play cloud computing environment comprises at least one of a datacenter, a virtual private network, a public cloud, a private cloud, a virtual private cloud, a hybrid cloud, or a multi-cloud environment.

5. The method of claim 3, wherein the cross-play cloud computing environment includes at least one of a user account database, a user authentication requirement, a user verification requirement, secure sign-in capability, a database of user activity history, or a vault containing user-owned assets.

6. The method of claim 3, wherein the cross-play cloud computing environment comprises dedicated server fleets.

7. The method of claim 3, wherein the cross-play cloud computing environment is operable to resolve any compute discrepancies between the plurality of independent entertainment platforms.

8. The method of claim 7, wherein the plurality of independent entertainment platforms comprises disparate asynchronous client systems.

9. The method of claim 1, wherein the at least one instance of an entertainment program comprises at least one of a multi-player video game, a multi-player virtual reality game, a flight simulator, an online video game, or a mobile video game.

10. The method of claim 1, wherein the two or more client devices comprise at least one of a desktop computer, a laptop computer, a mobile phone, a gaming console, a mobile gaming console, or a virtual reality device.

11. The method of claim 10, wherein the two or more client devices comprises a gaming console, the gaming console is at least one of an Xbox console or a PlayStation console.

12. The method of claim 3, wherein the synchronizing the multi-user functionality within the at least one instance of the entertainment program comprises:
receiving input from disparate asynchronous client systems running independent instances of the entertainment program; and
simulating multiplayer gameplay for the at least one instance of an entertainment program based on the input from the disparate asynchronous client systems.

13. The method of claim 3, wherein the synchronizing the multi-user functionality within the at least one instance of the entertainment program comprises:
synchronizing the multi-user functionality via an extract, transform, and load process.

14. The method of claim 1, wherein the entertainment program comprises at least one of a role-playing game, a first-person shooter, a battle royale game, an adventure game, a driving game, a side scroller, a puzzle game, a flight sim, a rogue-like game, a sports game, or an educational game.

15. The method of claim 1, wherein the synchronizing the multi-user functionality within the at least one instance of the entertainment program comprises:
enabling a client Xbox device and a client PC device to engage in a synchronized multiplayer session of a multi-player online role-playing game.

16. The method of claim 12, wherein the disparate asynchronous client systems comprise software running asynchronously on at least one of disparate microprocessors, disparate operating systems, or disparate networks.

17. The method of claim 12, wherein none of the independent instances of the entertainment program are from the same independent entertainment platform.

18. The method of claim 1, wherein the plurality of independent entertainment platforms comprises:
at least one of an operating system, a game console, an online gaming platform, or a mobile gaming platform.

19. The method of claim 1, wherein the two or more client devices are able to engage in synchronized multiplayer gameplay via disparate input modes.

20. The method of claim 19, wherein the disparate input modes comprise at least one of keyboard, mouse, keyboard and mouse, virtual reality controller, trackpad, trackball, video game controller, video game remote control, gesture control, voice control, head tracking, body tracking, brain signal control, or eye movement control.

21. The method of claim 3, wherein the cross-play cloud computing environment is configured to send a haptic signal of events to the two or more client devices to effectuate a distributed and coordinated haptic multi-user experience.

22. The method of claim 1, further comprising at least one of:
a) recording a multiplayer gameplay within the at least one instance of the entertainment program;
b) saving a recording of the multiplayer gameplay within the at least one instance of the entertainment program;
c) playing back a recording of the multiplayer gameplay within the at least one instance of the entertainment program;
d) editing a recording of the multiplayer gameplay within the at least one instance of the entertainment program;
e) publishing a recording of the multiplayer gameplay within the at least one instance of the entertainment program; or
f) sharing a recording of the multiplayer gameplay within the at least one instance of the entertainment program.

23. The method of claim 1, further comprising performing matchmaking to find suitably compatible users.

24. The method of claim 1, further comprising managing a cross-play social network including one or more of
a) compiling a friends list;
b) compiling a group membership list;
c) tracking online status;
d) compiling a leaderboard;
e) compiling an achievement list; or
f) establishing a moderator role.

25. The method of claim 1, further comprising managing a payment platform including one or more of:
a) providing a game or other media catalog;
b) providing an online ordering platform;
c) providing for secure user wallet accounts; or
d) providing a secure payment platform.

26. The method of claim 1, further comprising:
providing an analytics suite operable to track user data including at least one of usage statistics, time-in-game statistics, user activity statistics, multiplayer statistics, or user progress statistics,

27. The method of claim 1, further comprising modifying a gameplay feature based on usage statistics of the feature.

28. The method of claim 27, wherein the gameplay feature comprises at least one of a level of difficulty, a reward frequency, a powerup frequency, or a points award.

29. A system for providing cross-platform multi-user compatibility, the system comprising:
a cross-play cloud computing environment operable to independently execute at least one instance of an entertainment program;
wherein two or more client devices are able to access the at least one instance of the entertainment program asynchronously via one of a plurality of independent entertainment platforms;
wherein the two or more client devices are able to engage in multi-user functionality within the at least one instance of the entertainment program via the one of a plurality of independent entertainment platforms; and
wherein the cross-play cloud computing environment synchronizes the multi-user functionality within the at least one instance of the entertainment program.

30. The system of claim 29, wherein the multi-user functionality comprises:
at least one of multiplayer gaming, multi-user virtual experience, multi-user remote viewing, or multi-user account management.

31. The system of claim 29, wherein the cross-play cloud computing environment comprises at least one of a datacenter, a virtual private network, a public cloud, a private cloud, a virtual private cloud, a hybrid cloud, or a multi-cloud environment.

32. The system of claim 29, wherein the cross-play cloud computing environment includes at least one of a user account database, a user authentication requirement, a user verification requirement, secure sign-in capability, a database of user activity history, or a vault containing user-owned assets.

33. The system of claim 29, wherein the cross-play cloud computing environment comprises dedicated server fleets.

34. The system of claim 29, wherein the cross-play cloud computing environment is operable to resolve any compute discrepancies between disparate asynchronous client systems.

35. The system of claim 29, wherein the at least one instance of an entertainment program comprises at least one of a multi-player video game, a multi-player virtual reality game, a flight sim, an online video game, or a mobile video game.

36. The system of claim 29, wherein the two or more client devices comprise at least one of a desktop computer, a laptop computer, a mobile phone, a gaming console, a mobile gaming console, or a virtual reality device.

37. The system of claim 36, wherein the gaming console comprises at least one of an Xbox or a PlayStation.

38. The system of claim 29, wherein the cross-play cloud computing environment operable to independently execute at least one instance of an entertainment program comprises:
a cross-play cloud computing environment operable to
a) receive input from disparate asynchronous client systems running independent instances of the entertainment program; and
b) execute multiplayer gameplay for the at least one instance of an entertainment program based on the input from the disparate asynchronous client systems.

39. The system of claim 29, wherein the cross-play cloud computing environment synchronizes the multi-user functionality via an extract, transform, and load process.

40. The system of claim 29, wherein the entertainment program comprises at least one of a role-playing game, a first-person shooter, a battle royale game, an adventure game, a driving game, a side scroller, a puzzle game, a flight sim, a rogue-like game, a sports game, or an educational game.

41. The system of claim 29, wherein the cross-play cloud computing environment enables a client Xbox device joins a session of a massive multi-player online role-playing game, and wherein a client PC device joins the same session of the massive multiplayer online role-playing game.

42. The system of claim 41, wherein the cross-play cloud computing environment enables the client Xbox device and the client PC device to engage in a synchronized multiplayer session of the massive multi-player online role-playing game.

43. The system of claim 38, wherein the disparate asynchronous client systems comprise software running asynchronously on at least one of disparate microprocessors, disparate operating systems, or disparate networks.

44. The system of claim 38, wherein none of the independent instances of the entertainment program are from the same independent entertainment platform.

45. The system of claim 29, wherein the plurality of independent entertainment platforms comprises:
at least one of an operating system, a game console, an online gaming platform, or a mobile gaming platform.

46. The system of claim 29, wherein the two or more client devices are able to engage in synchronized multiplayer gameplay via disparate input modes.

47. The system of claim 46, wherein the disparate input modes comprise at least one of keyboard, mouse, keyboard and mouse, virtual reality controller, trackpad, trackball, video game controller, video game remote control, gesture control, voice control, head tracking, body tracking, brain signal control, or eye movement control.

48. The system of claim 29, wherein the cross-play cloud computing environment is configured to send a haptic signal of events to the two or more client devices to effectuate a distributed and coordinated haptic multi-user experience.

49. The system of claim 29, wherein the cross-play cloud computing environment is further configured to at least one of:
a) record the multiplayer gameplay within the at least one instance of the entertainment program;
b) save a recording of the multiplayer gameplay within the at least one instance of the entertainment program;
c) play back a recording of the multiplayer gameplay within the at least one instance of the entertainment program;
d) edit a recording of the multiplayer gameplay within the at least one instance of the entertainment program;
e) publish a recording of the multiplayer gameplay within the at least one instance of the entertainment program; or
f) share a recording of the multiplayer gameplay within the at least one instance of the entertainment program.

50. The system of claim 29, wherein the cross-play cloud computing environment is further configured to perform matchmaking to find suitable multiplayer users.

51. The system of claim 29, wherein the cross-play cloud computing environment further comprises a cross-play social network including one or more of
a) a friends list;
b) a group membership list;
c) online status;
d) a leaderboard;
e) an achievement list; or
f) a moderator role.

52. The system of claim 29, wherein the cross-play cloud computing environment further comprises a payment platform including one or more of:
a) a game or other media catalog;
b) an online ordering platform;
c) secure user wallet accounts; or
d) a secure payment platform.

53. The system of claim 29, wherein the cross-play cloud computing environment further comprises an analytics suite operable to provide user statistics for at least one of usage statistics, time-in-game statistics, user activity statistics, multiplayer statistics, or user progress statistics,

54. The system of claim 53, wherein the cloud computing environment is configured to modify a gameplay feature based on the usage statistics of the gameplay feature.

55. The system of claim 54, wherein the gameplay feature comprises at least one of a level of difficulty, a reward frequency, a powerup frequency, or a points award.

56. A computer program product comprising a non-transitory computer-readable medium including instructions that when executed on one or more processors cause the one or more processors to carry out the operations of any of claims 1-28.
